(19) United States
(12) Patent Application Publication
(10) Pub. No.: US 2026/0349681 A1
(43) Pub. Date: Nov. 5, 2026

(54) METHOD, APPARATUS, DEVICE AND STORAGE MEDIUM FOR CODE EDITING

(71) Applicant: Beijing Zitiao Network Technology Co., Ltd., Beijing (CN)

(72) Inventors: Yizhou LIU, Beijing (CN); Pengfei GAO, Beijing (CN); Zhao ZHANG, Beijing (CN); Chao PENG, Beijing (CN); Yexuan SHI, Beijing (CN); Yunxiang CAO, Beijing (CN); Ping YANG, Beijing (CN)

(21) Appl. No.: 19/487,286

(22) PCT Filed: Sep. 30, 2024
(86) PCT No.: PCT/CN2024/123076

§ 371 Date: Nov. 24, 2025

(51) Int. Cl. G06F 8/35

(52) U.S. Cl. CPC G06F 8/35

(57) ABSTRACT

A method, an apparatus, a device and storage medium of code editing are provided. The method provided herein includes: sending, to a target model, an editing request associated with a target code, the editing request indicating an output format of the target model, and the output format indicating the target model to output: a code fragment required to be replaced and an updated code fragment in a code file to be edited; obtaining response content output by the target model according to the output format, the response content comprising a first fragment to be replaced and a second fragment for replacing the first fragment; and generating an editing result of the target code by parsing the response content.

### FIELD

Example embodiments of the present disclosure generally relate to the field of computers, and in particular, to a method, an apparatus, a device and computer readable storage medium for code editing.

### BACKGROUND

With the development of computer technologies, generative models are gradually applied to various scenarios. For example, some generative models may provide automated code editing, code generation, code repair, and the like for an integrated development tool (IDE). It would be desirable to improve the code editing efficiency of such generative models.

### SUMMARY

In a first aspect of the present disclosure, a method for code editing is provided. The method includes: sending, to a target model, an editing request associated with a target code, the editing request indicating an output format of the target model, and the output format indicating the target model to output: a code fragment required to be replaced and an updated code fragment in a code file to be edited; obtaining response content output by the target model according to the output format, the response content comprising a first fragment to be replaced and a second fragment for replacing the first fragment; and generating an editing result of the target code by parsing the response content.

In a second aspect of the present disclosure, an apparatus for code editing is provided. The apparatus includes a request sending module configured to send, to a target model, an editing request associated with a target code, the editing request indicating an output format of the target model, and the output format indicating the target model to output: a code fragment required to be replaced and an updated code fragment in a code file to be edited; a content obtaining module configured to obtain response content output by the target model according to the output format, the response content comprising a first fragment to be replaced and a second fragment for replacing the first fragment; and a result generation module configured to generate an editing result of the target code by parsing the response content.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by a processor to implement the method of the first aspect.

In a fifth aspect of the present disclosure, a computer program product is provided. The computer program product includes computer-executable instructions that, when executed by a processor, implement the method according to the first aspect of the present disclosure.

It should be understood that the content described in this summary section is not intended to limit the key features or critical features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference signs indicate the same or similar elements, where:

FIG. 1 illustrates a schematic diagram of an example environment in which the embodiments of the present disclosure can be implemented;

FIG. 2 illustrates a flowchart of an example process of code editing according to some embodiments of the present disclosure;

FIG. 3 illustrates a schematic diagram of an example process of code editing according to some embodiments of the present disclosure;

FIG. 4 illustrates a schematic structural block diagram of an example apparatus for code editing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout herein and any type of embodiments may be included in any section/subsection. Furthermore, the embodiments described in any section/subsection may be combined in any manner with any other embodiment described in the same section/subsection and/or in a different section/subsection.

In the description of the implementations of the present disclosure, the term “comprising/including” and its equivalents should be construed as being open-ended inclusive, i.e., “including, but not limited to”. The term “based on” should be construed as “based at least in part on”. The terms “one embodiment” or “the embodiment” should be construed as “at least one embodiment”. The term “some embodiments” should be construed as “at least some embodiments”. Other definitions, either explicit or implicit, may also be included below. The terms “first”, “second” and the like may refer to different objects or the same object. Other explicit or implicit definitions may also be included below.

Embodiments of the present disclosure may involve data of a user, acquisition and/or use of data, and the like. These aspects comply with corresponding laws and regulations and relevant provisions. In the embodiments of the present disclosure, all the collection, acquisition, process, processing, forwarding, use of data, and the like are carried out with the knowledge and confirmation of the user. Accordingly, when implementing the embodiments of the present disclosure, the types, use ranges, use scenarios of data or information that may be involved and the like should be notified to the user and the user's authorization should be obtained in an appropriate manner according to the relevant laws and regulations. The specific notification and/or authorization manner may vary according to actual situations and application scenarios, and the scope of the present disclosure is not limited in this respect.

In the solutions in the present specification and embodiments, in case that personal information processing is involved, the processing will be carried out on the premise of there is a basis of legality (for example, consent of a subject of the personal information is obtained, or it is necessary to fulfill a contract and so on), and the processing will be carried out only within a specified or agreed range. The user's refusal to process personal information other than necessary information required for the basic functions will not affect the use of the basic functions by the user.

According to traditional schemes, an agent has to rewrite the entire code file during the code editing process, and the code format requirements are strict. This leads to a high cost for generating code, and is prone to introduce new syntax errors and poor stability, and thus affecting the efficiency of code editing.

The embodiment of the present disclosure provides a solution for code editing. According to the solution, an editing request associated with a target code may be sent to a target model, the editing request indicates an output format of the target model, and the output format indicates the target model to output: a code fragment required to be replaced and an updated code fragment in a code file to be edited. Response content output by the target model according to the output format is obtained, the response content includes a first fragment to be replaced and a second fragment for replacing the first fragment. An editing result of the target code is then generated by parsing the response content.

In this way, the embodiments of the present disclosure can specify the code editing output format of a model, to enable more efficient and accurate code editing by parsing formatted information, thereby improving the efficiency and accuracy of code editing.

Various example implementations of this solution are described in detail below in connection with the accompanying drawings.

### Example Environment

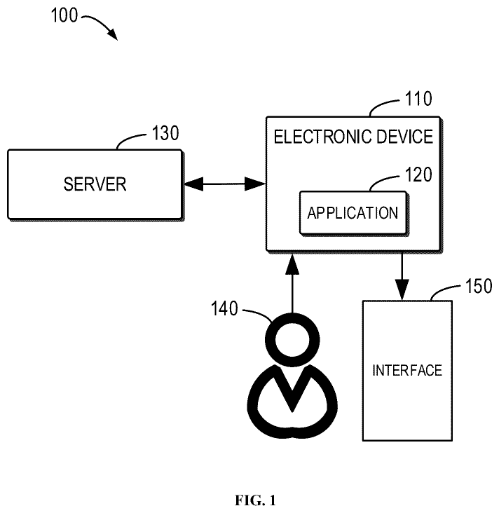

FIG. 1 illustrates a schematic diagram of an example environment 100 in which embodiments of the present disclosure can be implemented. As shown in FIG. 1, the example environment 100 may include an electronic device 110.

In the example environment 100, the electronic device 110 may run an application 120 that supports interface interaction. The application 120 may be any suitable type of application for interface interaction, and examples of which may include, but are not limited to: a code editing application, a video application, a social application, or any other suitable application. The user 140 may interact with the application 120 via the electronic device 110 and/or an attached device thereof.

In the environment 100 of FIG. 1, in a case that the application 120 is active, the electronic device 110 may present, via the application 120, an interface 150 for supporting interface interaction.

In some embodiments, the electronic device 110 communicates with the server 130 to enable provision of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game console, a VR (virtual reality)/AR (augmented reality) device, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including accessories and peripherals of these devices, or any combination thereof. In some embodiments, the electronic device 110 can also support any type of interface for a user (such as, a “wearable” circuit, and so on).

The server 130 may be a standalone physical server, or may be a server cluster or a distributed system that consists of a plurality of physical servers, or may be a cloud server that provides basic cloud computing services, such as cloud services, cloud databases, cloud computing, cloud functions, cloud storage, network services, cloud communications, middleware services, domain name services, security services, content distribution networks, big data and artificial intelligence platforms, and so on. The server 130 may include, for example, a computing system/server, such as a mainframe, an edge computing node, a computing device in a cloud environment, and the like. The server 130 may provide background services for the application 120 supporting content presentation in the electronic device 110.

A communication connection may be established between the server 130 and the electronic device 110. The communication connection may be established via a wired or wireless manner. The communication connection may include, but is not limited to, a Bluetooth connection, a mobile network connection, a Universal Serial Bus (USB) connection, a Wireless Fidelity (Wi-Fi) connection, and so on. The embodiments of the present disclosure are not limited in this aspect. In the embodiments of the present disclosure, the server 130 and the electronic device 110 may implement signaling interaction through a communication connection in between.

It should be understood that the structures and functions of various elements in the environment 100 are described for illustrative purposes only, and do not imply any limitation to the scope of the present disclosure.

Some example embodiments of the present disclosure will continue to be described below with reference to the accompanying drawings.

### Example Process

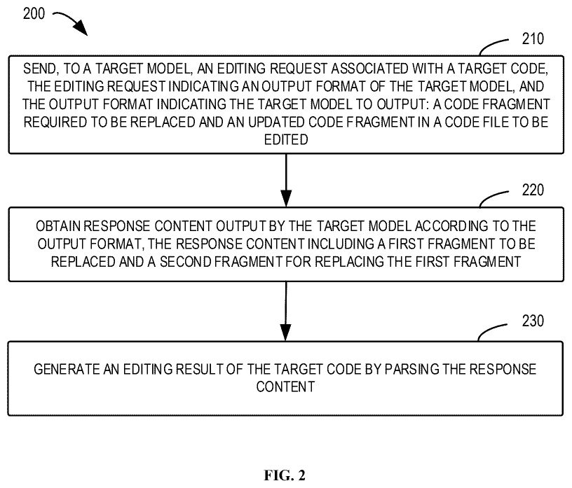

FIG. 2 illustrates a flowchart of an example process 200 of code editing according to some embodiments of the present disclosure. The process 200 may be implemented at the electronic device 110. The process 200 is described below with reference to FIG. 1.

As shown in FIG. 2, at block 210, the electronic device 110 sends an editing request associated with a target code to the target model. The editing request indicates an output format of the target model, and the output format indicates the target model to output: a code fragment required to be replaced and an updated code fragment in a code file to be edited.

In some embodiments, the target model may be a language model. In addition, the target model may be associated with an agent or a bot. By way of example, the agent or bot may process the editing request input by the user based on configured knowledge information, plug-in information, a system prompt, and the like.

In some embodiments, the electronic device 110 may send the editing request associated with the target code to the target model in response to an invocation by the agent of an editing tool associated with the target code.

In some embodiments, the agent may retrieve the target code that needs to be edited from the code file to be edited based on a code retrieval tool. Such a code file to be edited may be, for example, a code file that has problems or defects and needs to be modified or replaced. In some embodiments, the agent may invoke the editing tool associated with the target code in response to receiving the target code that needs to be edited. Further, the electronic device 110 may send, in response to the invocation by the agent of the editing tool associated with the target code, the editing request associated with the target code to the target model, thereby enabling debugging and repair of the target code.

In some embodiments, the editing request may indicate the output format of the target model. Such an output format may include a code fragment (second content portion) in the code file to be edited that required to be replaced and an updated code fragment (third content portion). In addition, such an output format may further include a file identification (first content portion) of the code file to be edited. By way of example, such a file identification may be information such as a storage path or name of the code file to be edited.

By way of example, a prompt sent to the target model may be used to indicate the output format of the target model. For example, such an output format may be as follows.

<diffs>
<file>XXX.py </file>
<<<<<<< REPLACE
{exact copy of old line(s) you would like to change}
=======
new line(s) to replace
>>>>>>> UPDATE
</diffs>

In an example of the output format described above, “<file>XXX.py</file>” may be used to fill the file identification (i.e., the first content portion) the code file to be edited; “{exact copy of old line(s) you would like to change}” may fill the code fragment to be replaced (i.e., the second content portion); and “new line(s) to replace” may fill the updated code fragment (i.e., the third content portion).

In some embodiments, the editing request may further include task description information. Such task description information may include, for example, information such as the file identification, error information, a run command, a question description, and related code of the code file to be edited, so as to facilitate the recognition and editing operations for the agent.

In this way, the electronic device 110 may obtain the response content in a relatively simple output format based on the editing request associated with the target code, thereby reducing the magnitude of the content output by the model and improving the efficiency of code processing.

At block 220, the electronic device 110 obtains response content output by the target model according to the output format. The response content includes a first fragment to be replaced and a second fragment for replacing the first fragment.

As discussed above, since the prompt of the target model may specify the output format of the content to be output by the target model, the target model may output the response content that matches the example of the output format as introduced above. Specifically, the target model may respectively fill the three content portions of the output format with corresponding content to indicate the code file to be edited, the code fragment to be replaced (i.e., the first fragment), and the updated code fragment (i.e., the second fragment).

In some embodiments, such a first fragment may include one or more code lines that need to be edited, and correspondingly, the second fragment may include a same number of code lines for replacement.

In summary, the electronic device 110 may obtain the response content including the file identification information of the code file to be edited, the first fragment to be replaced, and the second fragment for replacement.

In this process, the agent only needs to output the portion of code that needs to be edited without having to rewrite the code file to be edited, thus improving the processing efficiency of code editing.

At block 230, the electronic device 110 generates an editing result of the target code by parsing the response content.

In some embodiments, the electronic device 110 may parse the response content according to the output format to extract the first fragment to be replaced and the second fragment for replacing the first fragment. By way of example, the electronic device 110 may parse the output response content to extract the first fragment and the second fragment.

Taking the example output format given above as an example, the electronic device 110 may locate and extract the corresponding file identification, the first fragment, and the second fragment based on the output format.

In some scenarios, the first fragment filled by the target model may not necessarily be consistent with the code fragment in the original code file. In some embodiments, the electronic device 110 may further determine whether the target code includes a target portion that matches the first fragment. By way of example, the electronic device 110 may determine a similarity between a code fragment in the target code (or a code file to be edited) and the first fragment, and further determine a relationship between the similarity and a similarity threshold, to determine whether the target code includes a code fragment that matches the first fragment.

In some embodiments, the electronic device 110 may provide, in response to the target code not including the target portion (e.g., the similarity is less than the similarity threshold), a feedback message regarding an editing failure to the target model, to indicate that the code fragment does not exist in the code file currently to be edited.

In some embodiments, the electronic device 110 may replace, in response to the target code including the target portion (e.g., the similarity is greater than the similarity threshold), the target portion with the second fragment to generate the editing result of the target code. In some embodiments, such editing result may be presented in the form of difference control (e.g., unified diff text).

In some embodiments, the editing result of the target code may preserve the replaced target portion and the second fragment for difference control. By way of example, the electronic device 110 may generate a unified diff text from the target code and the modified target code for difference control, to indicate a mark of operations such as addition, deletion, and modification performed by the agent on the code fragments in the target code.

For the purpose of validating the editing result, the electronic device 110 may further validate the editing result to improve the accuracy of code editing. The validation of the editing result will be described below.

In some embodiments, the electronic device 110 may determine whether the editing result of the target code satisfies a preset constraint. For example, the preset constraint may be, for example, that the editing result does not have a syntax error, a type error, a naming error, a semantic error, a style and formatting problem, a security problem, a performance problem, a potential error, a code complexity issue, a dependency issue and so on.

In some embodiments, the electronic device 110 may utilize a static checking tool to determine whether the editing result includes the syntax error and/or any type of error described above. As an example, such a static checking tool may be a language service, a linter, or the like.

In some embodiments, the electronic device 110 may provide, in response to the edit result satisfying the preset constraint, the edit result to the target model, and save the editing of the target code for viewing by the user.

In some embodiments, the electronic device 110 may provide, in response to the editing result not satisfying the preset constraint, description information about the editing result not satisfying the preset constraint to the target model, and cancel the editing of the target code. By way of example, if the editing result does not pass the static check, the electronic device 10 may return the error information of the static check to the agent, and undo the previous change to the target code, that is, not save the current modification. Further, the agent may continue to perform the next round of code editing operations based on the error report information, the target code, and the task description information, until the final editing result is derived through static check.

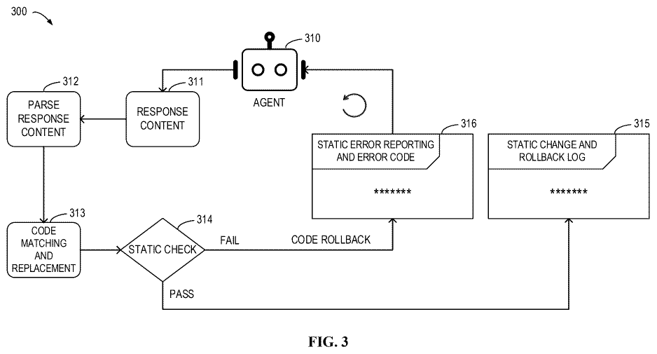

FIG. 3 illustrates a schematic diagram of an example process of code editing according to some embodiments of the present disclosure. As shown in FIG. 3, at block 310, the agent may receive the editing request, the target code and the task description information. At block 311, the electronic device 110 may obtain corresponding response content based on the received content described above, where such response content may include the file identification information of the file to be edited, the code fragment that needs to be replaced (first fragment), and the updated code fragment (second fragment).

Further, at block 312, the electronic device 110 may parse the response content to extract the first fragment and the second fragment. At block 313, the electronic device 110 may determine, in the target code (or the code file to be edited), a fragment that has a similarity to the first fragment greater than a similarity threshold, and replace the fragment to obtain the editing result.

Further, at block 314, the electronic device 110 may validate the editing result based on a static check. At block 315, if the editing result passes the static check, a final editing text may be formed. At block 316, if the editing result does not pass the static check, the above steps need to be continued until the final editing text is generated. Therefore, the target model may invoke the agent 310 to complete the editing operation of the code file to be edited.

In this way, the embodiments of the present disclosure can simplify the code editing process and provide a simpler output format of the response content, and further, the electronic device can perform static check on the editing result of the target code, thereby improving the output efficiency and accuracy of the target model.

In addition, by encapsulating the code editing capability described above into a code editing tool that can be invoked by the agent, the embodiments of the present disclosure can further improve the accuracy and reliability of the editing code by the agent, and improve the efficiency of code development.

### Example Apparatus and Device

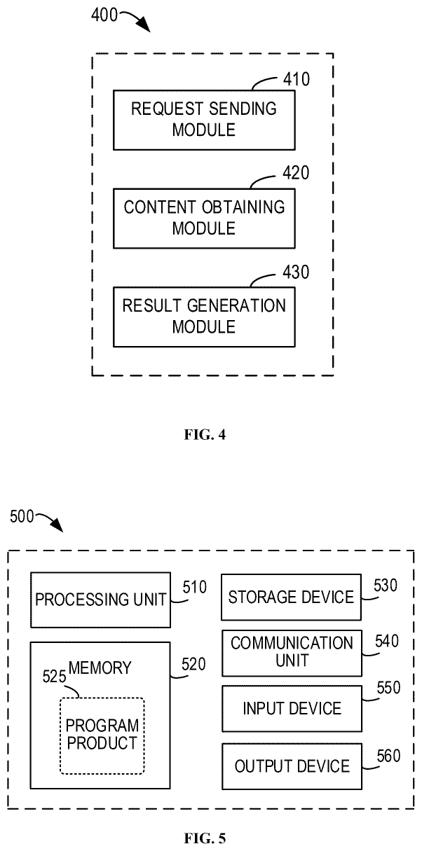

Embodiments of the present disclosure also provide a corresponding apparatus for implementing the method or process described above. FIG. 4 illustrates a schematic structural block diagram of an example apparatus 400 for code editing according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes a request sending module 410 configured to send, to a target model, an editing request associated with a target code, the editing request indicating an output format of the target model, and the output format indicating the target model to output: a code fragment required to be replaced and an updated code fragment in a code file to be edited; a content obtaining module 420 configured to obtain response content output by the target model according to the output format, the response content including a first fragment to be replaced and a second fragment for replacing the first fragment; and a result generation module 430 configured to generate an editing result of the target code by parsing the response content.

In some embodiments, the output format includes: a first content portion for file identification of the code file to be edited; a second content portion for filling the code fragment required to be replaced; and; and a third content portion for filling the updated code fragment.

In some embodiments, the apparatus 400 further includes a content parsing module configured to parse the response content according to the output format to extract the first fragment to be replaced and the second fragment for replacing the first fragment.

In some embodiments, the result generation module 430 is further configured to determine whether the target code includes a target portion matching the first fragment; and replace, in response to the target code including the target portion, the target portion with the second fragment to generate the editing result of the target code.

In some embodiments, the apparatus 400 further includes a message feedback module configured to provide, in response to the target code not including the target portion, a feedback message regarding an editing failure to the target model.

In some embodiments, the editing result preserves both the replaced target portion and the second fragment.

In some embodiments, the apparatus 400 further includes a first processing module configured to determine whether the editing result of the target code satisfies a preset constraint; and provide, in response to the editing result satisfying the preset constraint, the editing result to the target model, and save the editing of the target code.

In some embodiments, the apparatus 400 further includes a second processing module configured to provide, in response to the editing result not satisfying the preset constraint, description information about the editing result not satisfying the preset constraint to the target model, and cancel the editing of the target code.

In some embodiments, the first processing module is further configured to determine, with a static checking tool, whether the editing result includes a syntax error.

In some embodiments, the target model is associated with an agent, and the request sending module 410 is further configured to send, in response to an invocation of an editing tool associated with the target code by the agent, the editing request associated with the target code to the target model.

The modules included in the apparatus 400 may be implemented in various manners, including software, hardware, firmware, or any combination thereof. In some embodiments, one or more units may be implemented with software and/or firmware, for example machine-executable instructions stored on a storage medium. In addition to or as an alternative to machine-executable instructions, part or all of the modules in the apparatus 400 may be implemented, at least in part, by one or more hardware logic components. As an example and not a limitation, example types of hardware logic components that may be used include field programmable gate arrays (FPGAs), application specific integrated circuits (ASICs), application specific standard products (ASSPs), system-on-a-chip (SOCs), complex programmable logic devices (CPLDs), and the like.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units executes computer-executable instructions in parallel, to improve parallel processing capability of electronic device 500.

The electronic device 500 typically includes a plurality of computer storage media. Such media may be any available media accessible by the electronic device 500, including, but not limited to, volatile and non-volatile media, removable and non-removable media, and so on. The memory 520 may be a volatile memory (e.g., register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data (e.g., training data for training), and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk (e.g., a “floppy disk”) and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with other electronic devices through a communication medium. Additionally, the functionality of components of the electronic device 500 may be implemented by a single computing cluster or a plurality of computing machines, and these computing machines can communicate through a communication connection. Thus, the electronic device 500 may operate in a networked environment using logical connections with one or more other servers, network personal computers (PCs), or another network node.

The input device 550 may be one or more input devices, such as a mouse, a keyboard, a trackball, and so on. The output device 560 may be one or more output devices, for example a display, a speaker, a printer, and so on. The electronic device 500 may also communicate with one or more external devices (not shown) through the communication unit 540 as needed. The external devices, such as storage devices, display devices, and the like, communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the methods described above. According to example implementations of the present disclosure, a computer program product is further provided. The computer program product is tangibly stored on a non-transitory computer-readable medium and includes computer-executable instructions, and the computer-executable instructions are executed by a processor to implement the methods described above.

Aspects of the present disclosure are described herein with reference to flowcharts and/or block diagrams of methods, apparatuses, devices, and computer program products implemented in accordance with the present disclosure. It should be understood that each block of the flowcharts and/or block diagrams, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by the processing unit of the computer or other programmable data processing apparatus, produce means to implement the functions/acts specified in one or more blocks of the flowcharts and/or block diagrams. These computer-readable program instructions may also be stored in a computer-readable storage medium, and such instructions cause the computer, the programmable data processing apparatus, and/or other devices to function in a particular manner, such that the computer-readable medium storing instructions includes an article of manufacture including instructions to implement aspects of the functions/acts specified in one or more blocks of the flowcharts and/or block diagrams.

The computer-readable program instructions may be loaded onto a computer, other programmable data processing apparatus, or other devices, such that a series of operational steps are performed on the computer, other programmable data processing apparatus, or other devices to cause a computer-implemented process such that the instructions executed on the computer, other programmable data processing apparatus, or other devices implement the functions/acts specified in one or more blocks of the flowcharts and/or block diagrams.

The flowchart and block diagrams in the figures illustrate architecture, functionality, and operation of possible implementations of systems, methods, and computer program products according to various implementations of the present disclosure. In this regard, each block in the flowchart or block diagram may represent a module, program fragment, or portion of instructions, which include one or more executable instructions for implementing the specified logical function. In some implementations as alternatives, the functions designated in the blocks may also occur in a different order than that designated in the figures. For example, two consecutive blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified function or action, or may be implemented in a combination of dedicated hardware and computer instructions.

Various implementations of the present disclosure have been described above, which are illustrative, not exhaustive, and are not limited to the implementations as disclosed. Many modifications and variations will be apparent to those of ordinary skill in the art without departing from the scope and spirit of the various implementations disclosed. The selection of the terminology used herein is intended to best explain the principles of the implementations, practical applications, or improvements to techniques in the marketplace, or to enable others of ordinary skill in the art to understand the various implementations disclosed herein.

1. A method for code editing, comprising:
sending, to a target model, an editing request associated with a target code, the editing request indicating an output format of the target model, and the output format indicating the target model to output: a code fragment required to be replaced and an updated code fragment in a code file to be edited;
obtaining response content output by the target model according to the output format, the response content comprising a first fragment to be replaced and a second fragment for replacing the first fragment; and
generating an editing result of the target code by parsing the response content.

2. The method of claim 1, wherein the output format comprises:
a first content portion for file identification of the code file to be edited;
a second content portion for filling the code fragment required to be replaced; and
a third content portion for filling the updated code fragment.

3. The method of claim 1, further comprising:
parsing the response content according to the output format to extract the first fragment to be replaced and the second fragment for replacing the first fragment.

4. The method of claim 1, wherein generating the editing result of the target code by parsing the response content comprises:
determining whether the target code comprises a target portion matching the first fragment; and
replacing, in response to the target code comprising the target portion, the target portion with the second fragment to generate the editing result of the target code.

5. The method of claim 4, further comprising:
providing, in response to the target code not comprising the target portion, a feedback message regarding an editing failure to the target model.

6. The method of claim 4, wherein the editing result preserves both the replaced target portion and the second fragment.

7. The method of claim 1, further comprising:
determining whether the editing result of the target code satisfies a preset constraint; and
providing, in response to the editing result satisfying the preset constraint, the editing result to the target model, and saving the editing of the target code.

8. The method of claim 7, further comprising:
providing, in response to the editing result not satisfying the preset constraint, description information about the editing result not satisfying the preset constraint to the target model, and canceling the editing of the target code.

9. The method of claim 7, wherein determining whether the editing result of the target code satisfies the preset constraint comprises:
determining, with a static checking tool, whether the editing result comprises a syntax error.

10. The method of claim 1, wherein the target model is associated with an agent, and sending the editing request associated with the target code to the target model comprises:
sending, in response to an invocation of an editing tool associated with the target code by the agent, the editing request associated with the target code to the target model.

11. (canceled)

12. An electronic device comprising:
at least one processor; and
at least one memory coupled to the at least one processor and storing instructions for execution by the at least one processor, wherein the instructions, when executed by the at least one processor, cause the electronic device to perform acts comprising:
sending, to a target model, an editing request associated with a target code, the editing request indicating an output format of the target model, and the output format indicating the target model to output: a code fragment required to be replaced and an updated code fragment in a code file to be edited;
obtaining response content output by the target model according to the output format, the response content comprising a first fragment to be replaced and a second fragment for replacing the first fragment; and
generating an editing result of the target code by parsing the response content.

13. A non-transitory computer-readable storage medium having a computer program stored thereon, wherein the computer program is executable by a processor to implement acts comprising:
sending, to a target model, an editing request associated with a target code, the editing request indicating an output format of the target model, and the output format indicating the target model to output: a code fragment required to be replaced and an updated code fragment in a code file to be edited;
obtaining response content output by the target model according to the output format, the response content comprising a first fragment to be replaced and a second fragment for replacing the first fragment; and
generating an editing result of the target code by parsing the response content.

14. (canceled)

15. The electronic device of claim 12, wherein the output format comprises:
a first content portion for file identification of the code file to be edited;
a second content portion for filling the code fragment required to be replaced; and
a third content portion for filling the updated code fragment.

16. The electronic device of claim 12, wherein the acts further comprise:
parsing the response content according to the output format to extract the first fragment to be replaced and the second fragment for replacing the first fragment.

17. The electronic device of claim 12, wherein generating the editing result of the target code by parsing the response content comprises:
determining whether the target code comprises a target portion matching the first fragment; and
replacing, in response to the target code comprising the target portion, the target portion with the second fragment to generate the editing result of the target code.

18. The electronic device of claim 17, wherein the acts further comprise:
providing, in response to the target code not comprising the target portion, a feedback message regarding an editing failure to the target model.

19. The electronic device of claim 17, wherein the editing result preserves both the replaced target portion and the second fragment.

20. The electronic device of claim 12, wherein the acts further comprise:
determining whether the editing result of the target code satisfies a preset constraint; and
providing, in response to the editing result satisfying the preset constraint, the editing result to the target model, and saving the editing of the target code.

21. The electronic device of claim 20, wherein the acts further comprise:
providing, in response to the editing result not satisfying the preset constraint, description information about the editing result not satisfying the preset constraint to the target model, and canceling the editing of the target code.

22. The electronic device of claim 20, wherein determining whether the editing result of the target code satisfies the preset constraint comprises:
determining, with a static checking tool, whether the editing result comprises a syntax error.
